(19) United States
(12) Patent Application Publication
(10) Pub. No.: US 2014/0113203 A1
(43) Pub. Date: Apr. 24, 2014

(54) ELECTROLYTE ADDITIVES FOR LITHIUM ION BATTERY AND LITHIUM ION BATTERY CONTAINING SAME

(71) Applicants: JIE XIAO, RICHLAND, WA (US); JIANMING ZHENG, RICHLAND, WA (US); JIGUANG ZHANG, RICHLAND, WA (US); EDUARD N. NASYBULIN, RICHLAND, WA (US); WU XU, RICHLAND, WA (US)

(72) Inventors: JIE XIAO, RICHLAND, WA (US); JIANMING ZHENG, RICHLAND, WA (US); JIGUANG ZHANG, RICHLAND, WA (US); EDUARD N. NASYBULIN, RICHLAND, WA (US); WU XU, RICHLAND, WA (US)

(73) Assignee: BATTELLE MEMORIAL INSTITUTE, RICHLAND, WA (US)

(21) Appl. No.: 14/059,109

(22) Filed: Oct. 21, 2013

Related U.S. Application Data
(60) Provisional application No. 61/716,908, filed on Oct. 22, 2012.

(51) Int. Cl. H01M 10/0567; C07F 5/02; H01M 10/0525

(52) U.S. Cl. CPC H01M 10/0567; H01M 10/0525; C07F 5/027
USPC 429/332; 429/200; 568/6

(57) ABSTRACT

Electrolyte additives are described that enhance cycling stability of electrolytes and lithium composite electrodes that prolong cycling lifetimes and improve electrochemical performance of lithium ion batteries. The electrolyte additives minimize voltage fading and capacity fading observed in these batteries by reducing accumulation of passivation films on the electrode surface.

### CROSS REFERENCE TO RELATED APPLICATION

This is a Non-Provisional application that claims priority from U.S. Provisional Application No. 61/716,908 filed 22 Oct. 2012 entitled “Additive for Lithium Ion Battery Cathode and Process”, which reference is incorporated in its entirety herein.

### STATEMENT REGARDING RIGHTS TO INVENTION MADE UNDER FEDERALLY-SPONSORED RESEARCH AND DEVELOPMENT

This invention was made with Government support under Contract DE-AC05-76RLO1830 awarded by the U.S. Department of Energy. The Government has certain rights in the invention.

### FIELD OF THE INVENTION

The present invention relates generally to electrolytes of lithium-ion batteries. More particularly, the present invention includes electrolyte additives that stabilize long-term cycling stability of lithium-ion batteries.

### BACKGROUND OF THE INVENTION

In order to extend the driving range of electric vehicles (EV) and operation time of other battery powered electronic devices, an energy storage system with significantly improved capacity and energy density is needed. High energy cathode materials for lithium (Li) ion batteries can be used to power such vehicles. One of the promising high energy cathode materials is a lithium-manganese-rich (LMR) layered composite with a chemical formula of: xLi₂MnO₃.(1-x)LiMO₂, where M=nickel (Ni), cobalt (Co), and manganese (Mn). The composite electrode material can deliver a capacity of 200-250 Ah/kg at a C-rate of C/3, the highest among cathode materials currently. “C-rate” is defined as a charge or discharge rate equal to the capacity of a battery in one hour. For example, a battery having a capacity of 5 Amps per hour (or 5 Ah) that accepts a 20 Amp (20 A) current represents a charge rate of 4 C. However, problems remain for this class of cathode materials including, e.g., voltage fading, low initial Coulombic efficiency, poor cycling stability, and poor rate capability. This class of cathode materials also releases oxygen during the initial charging cycles. Released oxygen may react with the electrolyte during operation forming problematic interfacial films on the surface of the cathode materials that reduces power and electrochemical performance of the battery. And, at typical high cut-off voltages between, e.g., 4.6 V and 4.8 V, decomposition products such as lithium alkyl carbonate (Li₂CO₃), lithium fluoride (LiF), and other lithium-containing species of the form LiₓPO_{y}F_{z} can occur in the electrolytes which form thick (e.g., 10-15 nm) solid electrolyte interface (SEI) films on the surface of the cathode. Growth of SEI films leads to capacity fading and contributes to a poor rate performance. For example, the LMR cathode can deliver a discharge capacity of 250 mAh g⁻¹ at C/10, but delivers only 100 mAh g⁻¹ at 5 C (40% retention). Subsequent charge cycles may also be accompanied by a gradual transition in the composite material from a layered structure (phases) to a spinel-like structure. Instability in the layered structure of the composite material is directly related to the voltage fading phenomenon observed in this class of composite materials. Accordingly, new electrolyte materials are needed that increase the stability of the electrolytes and further control formation of SEI film layers and growth on the electrodes thereby improving stability and rate capability of these cathode materials. The present invention addresses these needs.

### SUMMARY OF THE INVENTION

The present invention includes electrolyte additives that enhance cycling stability of lithium-containing cathodes used in lithium-ion batteries. Electrolyte additives of the present invention include an electron deficient boron-containing compound configured with one or more fluorinated aryl and/or fluorinated alkyl functional groups. When added to a lithium-containing electrolyte in contact with the lithium-containing cathode, the boron-containing compound significantly enhances the number of stable charge-discharge cycles for the lithium-containing composite cathode when compared to the lithium ion battery that does not include the electrolyte additive.

The present invention also includes a lithium ion battery. The lithium ion battery may include: a cathode constructed of a layered lithium-containing composite. The lithium ion battery may also include an electrolyte that is in contact with the cathode. The electrolyte may include an electrolyte additive that contains an electron deficient boron-containing compound. The electron deficient boron-containing compound may contain one or more fluorinated aryl and/or fluorinated alkyl functional groups.

The electrolyte additive in the electrolyte decreases the voltage fading of the lithium ion battery to less than about 10% over a lifetime of at least 300 charge-discharge cycles as compared to the lithium ion battery without the electrolyte additive.

In various applications, electrolyte additives of the present invention also reduce capacity fading in the lithium battery to less than 20% on average over a lifetime of at least 300 charge-discharge cycles as compared to a capacity fading in batteries without the electrolyte additive.

In some applications, the electron deficient boron-containing compound in the electrolyte additive is tris(pentafluorophenyl)borane (TPFPB). TPFBP may be directly added into lithium-containing, carbonate-based organic electrolytes. In some applications, the electrolyte used in the lithium ion batteries contains, e.g., selected ratios of ethylene carbonate:dimethyl carbonate [EC:DMC], and lithium hexafluorophosphate (LIPF₆). The TPFPB electrolyte additive may confine oxygen-generating precursors by coordinating any released oxygen anions (O²⁻) in the vicinity of the boron atom during the charging cycle. The TPFPB electrolyte additive also dissolves or partially dissolves byproducts such as Li₂CO₃ and LiF formed at high charging voltages greater than 4.5V that keeps electrode/electrolyte interfacial resistances (i.e., R_{sf}+R_{ct}) stable, thereby prolonging the cycling lifetime and improving the electrochemical performance of the layered composite cathode.

In various applications, the electrolyte additive may include an electron deficient boron-containing compound including, e.g., 2-(pentafluorophenyl)-tetrafluoro-1,3,2-benzodioxaborole; 2-(pentafluorophenyl)-4,4,5,5-tetrakis(trifluoromethyl)-1,3,2-dioxaboralane; bis(1,1,1,3,3,3-hexafluoroisopropyl)pentafluorophenylboronate; 2,5-bis(trifluoromethyl phenyl)tetrafluoro-1,3,2-benzodioxaborole; and combinations of these various additives which contain fluorinated aryl and/or fluorinated alkyl functional groups.

In some applications, electrolyte additives may include a concentration in the electrolyte between about 0.01 Mol/L and about 0.3 Mol/L.

In some applications, the electrolyte additive may also include perfluorotributylamine (PFTBA) at a concentration of between about 0.1 wt % and about 3 wt %.

In various applications, electrolyte additives of the present invention when present in the electrolyte also decrease breakdown of the electrolyte at charging voltages or cut-off voltages less than about 5 V.

In various applications, electrolyte additives of the present invention also minimize effects stemming from release of oxygen into the electrolytes during charging. And, when added to the electrolyte of the Li-ion battery, electrolyte additives of the present invention minimize thickness of passivation films on the surface of the electrodes.

In some applications, the electrolyte additives may be added to an electrolyte that is a carbonate-based or carbonate-containing electrolyte. In some applications, the electrolyte additives may be introduced into an electrolyte including lithium hexafluorophosphate (LIPF₆) in a solvent containing ethylene carbonate (EC) and dimethyl carbonate (DMC). In some applications, the concentration of LiPF₆ in the electrolyte is between about 0.1 Mol/L and about 1 Mol/L and the ethylene carbonate (EC) to dimethyl carbonate (DMC) are in a ratio of [1:2] by volume

In some applications, the electrolyte additives in the electrolyte may be in contact with a layered composite cathode that includes: xLi₂MnO₃.(1-x)LiMO₂. The metal (M) may be selected from: lithium (Li), nickel (Ni), cobalt (Co), manganese (Mn), and combinations of these various metals, where (M) includes atom ratios that sum to a total of one (1). The number (x) may be any positive number less than or equal to 1.

In some applications, the LMR composite cathode includes: 0.5 Li₂MnO₃.0.5LiNi_{0.5}Mn_{0.5}O₂ [also written as Li[Li_{0.2}Ni_{0.2}Mn_{0.6}]O₂].

In some applications, the LMR composite cathode includes: Li₂MnO₃.0.5LiNi_{1/3}Co_{1/3}Mn_{1/3}O₂ [also written as Li[Li_{0.2}Mn_{0.54}Ni_{0.13}Co_{0.13}]O₂.

The purpose of the foregoing abstract is to enable the United States Patent and Trademark Office and the public generally, especially the scientists, engineers, and practitioners in the art who are not familiar with patent or legal terms or phraseology, to quickly determine the nature and essence of the technical disclosure of the application. The abstract is neither intended to define the invention of the application, which is measured by the claims, nor is it intended to be limiting as to the scope of the invention in any way. Accordingly, drawings and descriptions of the preferred embodiment set forth hereafter are to be regarded as illustrative in nature, and not restrictive. A more complete appreciation of the invention will be readily obtained by reference to the following description of the accompanying drawings in which like numerals in different figures represent the same structures or elements.

### BRIEF DESCRIPTION OF THE DRAWINGS

FIG. 1 shows chemical structures for representative electrolyte additives of the present invention for stabilizing electrolytes and layered composite electrodes in lithium-ion batteries.

FIG. 2 shows average voltage of a representative layered composite cathode in an electrolyte with and without an exemplary electrolyte additive of the present invention.

FIG. 3a compares cycling stability of a representative layered composite cathode in an electrolyte with and without an exemplary electrolyte additive of the present invention.

FIG. 3b compares Coulombic efficiency of a representative layered composite cathode in an electrolyte with and without an exemplary electrolyte additive of the present invention.

FIGS. 4a-4c compare charge-discharge profiles of a layered composite electrode in a baseline electrolyte with and without an exemplary electrolyte additive of the present invention at 0.1 C (25 mA g⁻¹).

FIG. 5a is a Nyquist plot that compares electrochemical impedance for a layered composite electrode in a baseline electrolyte with and without electrolyte additives of the present invention before cycling.

FIG. 5b is a Nyquist plot that compares electrochemical impedance for a layered composite electrode in a baseline electrolyte with and without electrolyte additives of the present invention after 300 cycles.

FIG. 5c shows a magnified high-frequency semicircle of FIG. 5b after 300 cycles and an equivalent circuit for spectral fitting.

### DETAILED DESCRIPTION

An electrolyte additive and process are detailed that enhance stability of electrolytes that serve to extend the charge/discharge cycling lifetimes of composite electrode materials in lithium-ion batteries. The present invention will be described in concert with a baseline electrolyte containing 1M LiPF₆ dissolved in a [1:2] volume ratio of ethyl carbonate (EC) and dimethyl carbonate (DMC), but the invention is not limited thereto as detailed herein. All electrolytes as will be employed by those of ordinary skill in the art for operation in lithium ion batteries are within the scope of the present invention. No limitations are intended. In the preceding and following descriptions, preferred embodiments of the present invention are shown and described by way of illustration of the best mode contemplated for carrying out the invention. It will be clear from the following description that the invention is susceptible of various modifications and alternative constructions. The present invention covers all modifications, alternative constructions, and equivalents falling within the spirit and scope of the invention as defined in the claims. Therefore the description should be seen as illustrative and not limiting.

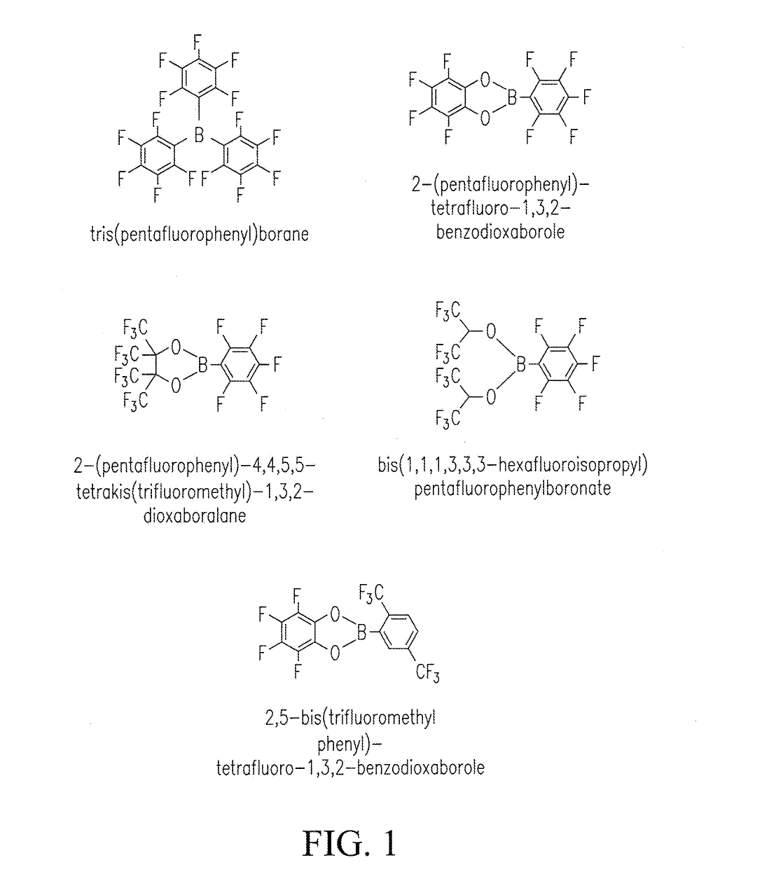

FIG. 1 shows chemical structures for representative electrolyte additives of the present invention for stabilizing electrolytes and layered composite electrodes in lithium-ion batteries. Electrolyte additives include, but are not limited to, e.g., tris(pentafluorophenyl)borane (TPFPB); 2-(pentafluorophenyl)-tetrafluoro-1,3,2-benzodioxaborole [(C₆F₄)O₂B(C₆F₅)]; 2-(pentafluorophenyl)-4,4,5,5-tetrakis(trifluoromethyl)-1,3,2-dioxaboralane [(C₆F₁₂)O₂B(C₆F₅)]; bis(1,1,1,3,3,3-hexafluoroisopropyl)pentafluorophenylboronate [C₃HF₆O)₂B(C₆F₅)]; 2,5-bis(trifluoromethyl phenyl)tetrafluoro-1,3,2-benzodioxaborole [(C₆F₄)O₂B(C₈H₃F₆)]; including combinations of these various additives. The electrolyte additives contain fluorinated aryl and/or fluorinated alkyl functional groups. In some embodiments, TPFPB is used as an electrolyte additive. TPFPB is a boron-based anion receptor. The TPFPB additive acts as an anion coordination center that readily accept oxygen anions (O²⁻) and confines the anions when released from the layered composites during charging.

### Voltage Fading and Capacity Fading

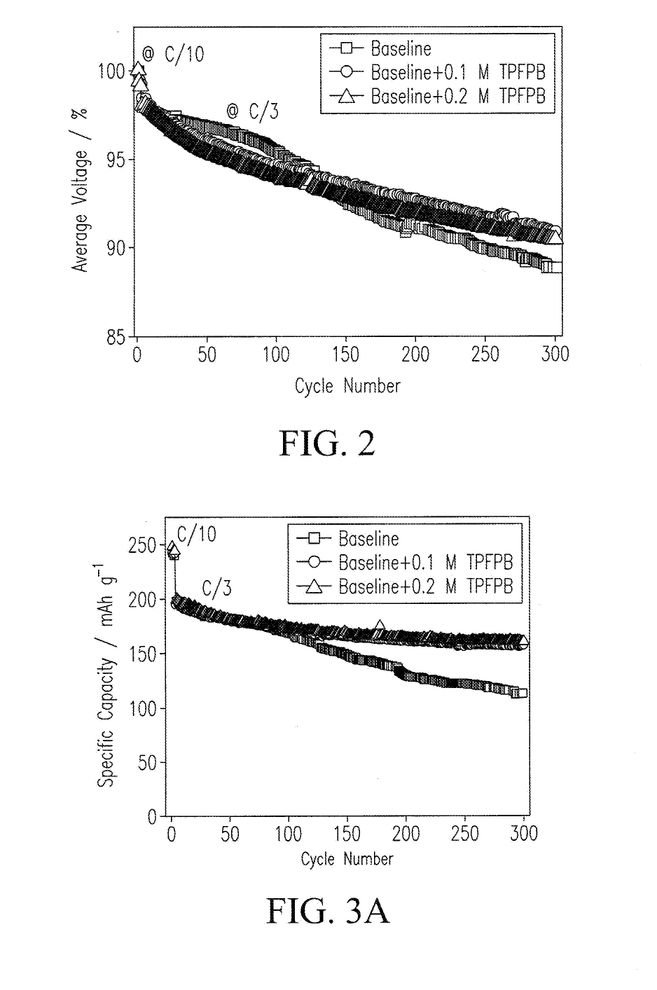

FIG. 2 compares average voltage of a representative layered composite cathode in an electrolyte with and without the exemplary TPFPB electrolyte additive. As shown in the figure, the baseline electrolyte experiences a consistent and steady decrease in voltage termed voltage fading over time. Voltage fading begins to appear in the baseline curve after 100 charging cycles and becomes pronounced after 150 charging cycles. The battery voltage decreases to about 11.2% of the full voltage after 300 cycles. In contrast, the battery containing 0.1 M TPFPB electrolyte additive and 0.2 M TPFPB electrolyte additive in the electrolyte experiences a voltage fade of less than 9.1% after 300 cycles. TABLE 1 lists typical voltage fading and capacity fading results for a representative lithium ion battery (cell) that includes a representative layered composite cathode and an electrolyte with and without the TPFPB electrolyte additive of the present invention.

TABLE 1 lists typical voltage fading and capacity fading results for a representative lithium ion cell configured with a representative layered composite cathode and a representative electrolyte with and without the exemplary TPFPB electrolyte additive.

| | Baseline Electrolyte | 0.1M TPFPB | 0.2M TPFPB |
|---|---|---|---|
| Voltage Fade after | 11.2% | 9.1% | 9.5% |
| 300 cycles | | | |
| Capacity fade after | 43.0% | 19.4% | 19.0% |
| 300 cycles | | | |

As shown in table, the electrolyte additive reduces the overall voltage fading in the battery to less than 10% on average after 300 cycles. Capacity fading in the battery containing the electrolyte additive is also reduced from 43% to less than 20% on average after 300 cycles.

### Composite Cathode Materials

Composite cathode materials suitable for use in concert with the present invention include, but are not limited to, e.g., LiCoO₂; LiMn₂O₄LiNiₓCo_{y}Mn_{z}O₂ [e.g., (NCM, e.g. LiNi_{1/3}Co_{1/3}Mn_{1/3}O₂ (333) and LiNi_{0.4}Co_{0.2}Mn_{0.4}O₂ (442), and etc.]; LiNi_{0.85}Co_{0.15}O₂; LiNi_{0.80}Co_{0.15}Al_{0.05}O₂; LiFePO₄; LiMnPO₄; LiFe₁₋ₓMnₓPO₄; Li₂FePO₄F; LiV₃O₈; Li₂FeSiO₄; Li₂MnSiO₄; Li₂Fe₁₋ₓMnₓSiO₄; and other suitable Li-containing composite materials.

### Electrolytes

In various embodiments, electrolytes suitable for use include, but are not limited to, e.g., as ionic liquid electrolyte LiPF₆-Py14TFSI (N-methyl-N-butylpyrrolidinium bis(trifluoromethylsulfonyl)imide), LiPF₆-PP13TFSI (N-methyl-N-propylpiperidinium bis(trifluoromethanesulfonyl)imide). In some embodiments, ether-based electrolytes such as LiTFSI in DOL/DME may be used.

### Electrolyte Additive and Dissolution of Oxygen

Layered composite cathodes suitable for use in lithium-ion batteries have a high capacity exceeding 250 mAh g⁻¹. However, these layered composite cathode materials release oxygen during initial charging cycles. Released oxygen can react with the carbonate based electrolyte at the layered composite/electrolyte interface. Reactions with released oxygen can form thick passivation films on the electrode surface that changes, reduces, or otherwise limits the long term cycling stability as well as the long term power output (rate capacity) of the battery.

Electrolyte additives of the present invention including TPFPB prevent or minimize reaction of oxygen with the electrolyte at the electrode surface oxygen is when released into the electrolyte from the layered composite cathode. The additive reduces formation of thick (10-15 nm) solid electrolyte interface (SEI) films on the surface of electrode stemming from reactions with oxygen during operation. The TPFPB additive in the electrolyte (with or without added FTBA) also maintains dissolution of oxygen (e.g., as a superoxide anion) when oxygen is released from the layered composite cathode during operation. Thus, less oxygen may be generated (i.e., through the 2O²⁻−2e⁻→O₂ process) over time. In addition, byproducts formed during charging either as a result of oxidation of the electrolyte by oxygen or from decomposition of the electrolyte at high operating voltages (>4.5 V) may be dissolved or at least partially dissolved in the TPFBP additive, reducing thickness of any formed SEI films on the surface of the cathode that are detrimental to cycling performance and rate performance.

Maintaining dissolution of released oxygen (and its superoxide anions) reduces or prevents reactions with the electrolyte or the composite electrode material itself thereby reducing formation of thick passivation films on the electrode surface that decrease performance. The TPFPB can be directly added to the carbonate-based organic electrolyte (e.g., LIPF₆ in EC/DMC) to increase dissolution of various lithium salts including, e.g., LiF, Li₂O₂, and Li₂O. The TPFPB boron anion receptor also promotes conductivity of the lithium salts in the electrolyte that enhances power density and re-chargeability.

In some embodiments, a quantity of perfluorotributylamine (PFTBA) between about 0.1 wt % and about 0.3 wt % may also be added whether alone or in combination with other electrolyte additives to improve solubility of O₂ in the electrolyte and reduce reactions that form SEI passivation films. The additives improve electrochemical performance of the layered composite cathode.

### Cycling Stability and Cycling Performance

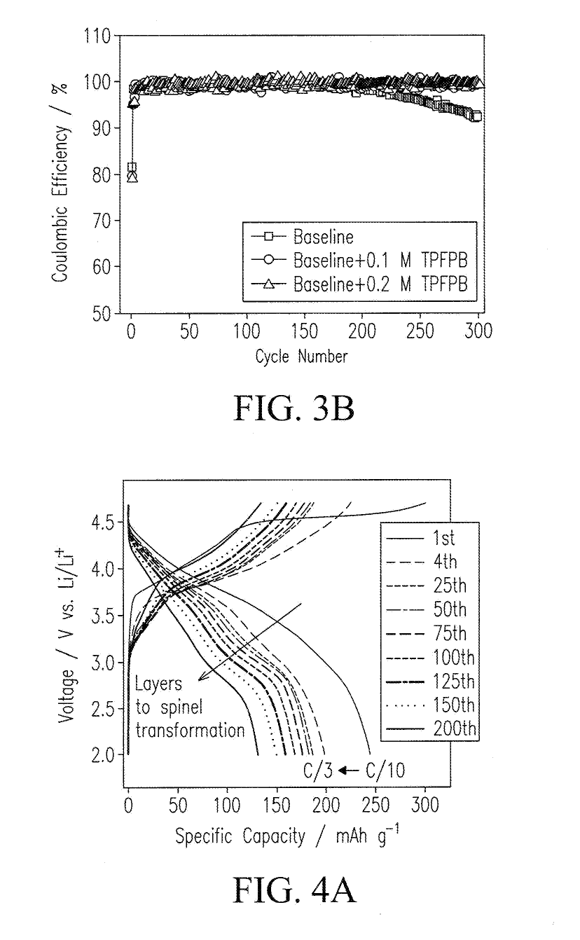

Electrolyte additives described herein including, tris(pentafluorophenyl)borane (TPFPB) with or without added PFTBA effectively stabilize electrolytes that extend the number of charge-discharge cycles and the stability and lifetimes of the layered composite electrodes [e.g., xLi₂MnO_{3-y}LiNi_{0.5}Mn_{0.5}O₂ and [Li[Li_{0.2}Ni_{0.2}Mn_{0.6}]O₂] during operation in lithium-ion batteries. FIGS. 3a-3c compare cycling stability and performance of a representative layered composite cathode [e.g., Li[Li_{0.2}Ni_{0.2}Mn_{0.6}]O₂] in the baseline electrolyte with and without an exemplary TPFPB electrolyte additive of the present invention plotted as a function of the cycle number. Results are measured at a C/3 rate after 3 initial formation cycles at 0.1 (or C/10), respectively. Voltage ranged between 2.0 V and 4.7 V. After activation, the electrode delivers a high discharge capacity of about 245 mAh g⁻¹ in all electrolytes initially, indicating that TPFPB additive has good compatibility with the composite cathode and the electrolyte during electrochemical processes. In the baseline electrolyte without TPFPB additive, a sharp drop in capacity (mAh/g) is observed beginning after 100 cycles at the C/3 rate, declining to about 130 mAh/g after 200 cycles and further declining to about 100 mAh/g after 300 cycles. Continuous capacity fading is attributed to deterioration of the electrode/electrolyte interface resulting from formation of thick passivation layers. An irreversible voltage plateau is observed in all three cells at about 4.4 V to about 4.6 V that is caused by irreversible loss of oxygen from the lattice of the composite cathode that causes corrosion/fragmentation of the bulk structure of the composite cathode.

In the electrolyte containing 0.1M TPFPB additive or 0.2M TPFPB additive, significant improvement is observed in the cell's capacity retention. Discharge capacities were maintained at 157 mAh g⁻¹ and 161 mAh g⁻¹ for cathodes tested with electrolytes containing 0.1 M and 0.2 M TPFPB, respectively, corresponding to high capacity retentions of 80.6% and 81.0%, as compared with a capacity of 56% without the additive. Results demonstrate that addition of TPFPB additive has a significant effect on the electrochemical performance of the layered composite. TPFPB in the electrolyte effectively accepts oxygen anions or radicals before O₂ is generated. Thus, damage to the electrode surface may be lowered than those without TPFPB. The additive also maintains dissolution of oxygen or superoxide anions generated and released during initial cycles.

FIG. 3b compares Coulombic efficiency in the electrolyte with and without TPFPB additive. In the absence of the TPFPB additive, Coulombic efficiency declines nearly 10% after 200 cycles. In the electrolyte containing TPFPB additive, Coulombic efficiency remains steady at nearly 100% through at least 300 cycles and longer.

### Charge-Discharge Profiles

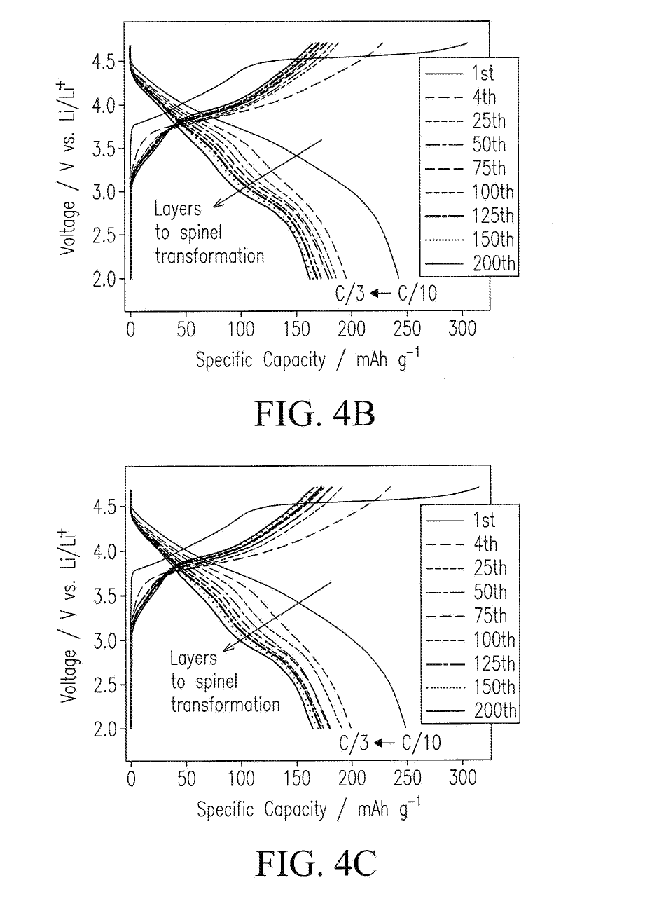

FIGS. 4a-4c compare charge-discharge profiles (voltage as a function of capacity) of a layered composite cathode, Li[Li_{0.2}Ni_{0.2}Mn_{0.6}]O₂, measured at a C/10 rate and C/3 rate in the electrolyte with and without TPFPB additive. In FIG. 4a, the discharge curve in the baseline electrolyte without the exemplary TPFPB additive shows significant voltage decay with cycling, which reduces the energy delivered from the battery. Voltage fading over time can be attributed to the gradual transition of the layered structure in the materials of the composite cathode to spinel structures. Electrolyte instability is also a function of high voltages (e.g., between 4.6 V and 4.8 V or greater) required to charge the battery. Instability of the electrolyte is worsened by generation of O₂²⁻ and O₂ released during activation (initial charging) of the Li₂MnO₃ component of the composite cathode.

In FIG. 4b and FIG. 4c after addition of 0.1 M and 0.2 M TPFPB additive, respectively, the separation gap between discharge curves narrows significantly showing that the additive is effective at reducing the thickness of passivation films formed on the cathode, stabilizes the electrode/electrolyte interface, reduces the transition of the layered structure of the composite electrode to the spinel structure, and eliminates or minimizes voltage fading phenomenon observed for layered composite cathodes as a function of time.

### Electrochemical Impedance

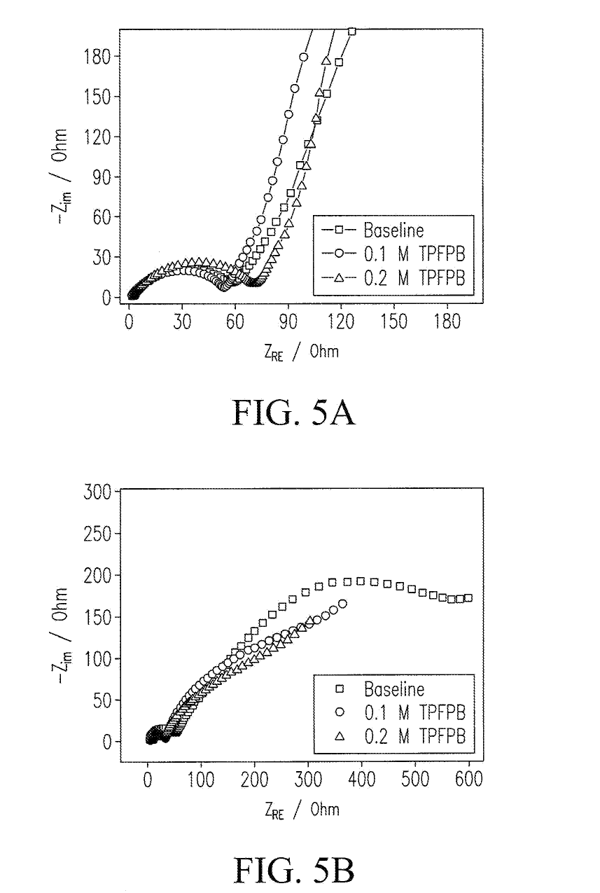

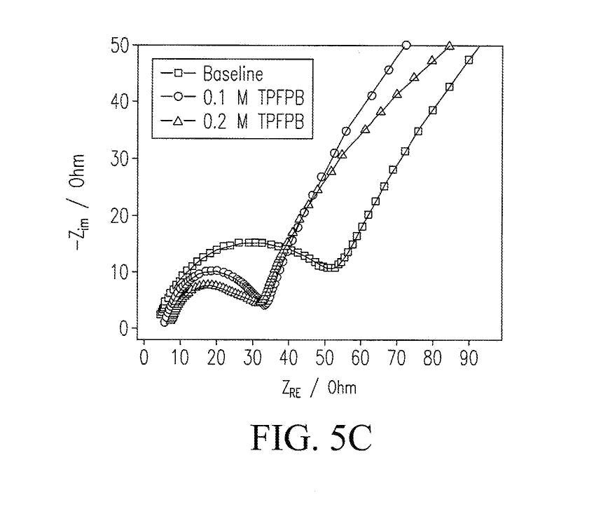

As discussed herein, electrode passivation films can form on the surface of the cathode as a consequence of the release of oxygen from the composite cathode material during charging. Formation of these films over time increases the impedance of the battery cell. Increases in impedance increase the energy required to effect flow of electrons through the battery electrolyte, which decreases battery efficiency. FIG. 5a plots impedance data in the baseline electrolyte prior to cycling with and without the exemplary TPFPB additive. The spectrum plots −Zᵢₘ (ohms) [i.e., the “imaginary” portion of the impedance measurement] as a function of Zᵣₑ (ohms) [i.e., the “real” portion of the impedance measurement.

In general, prior to cycling, impedance plots typically show a single semicircle with a high-to-medium frequency range from about 100 kHz to about 10 Hz, followed by a straight line (less than 10 Hz) at the low end of the spectrum. Before cycling, slight differences in the size of the semicircles may be observed. After cycling, two semicircles and a straight line are typically observed. The high-frequency semicircle at the low end of the spectrum reflects the surface film resistance (R_{sf}) stemming from growth of surface films on the surface of the electrode, and a corresponding increase in the electron charge-transfer resistance (R_{ct}). As detailed herein, growth of SEI films passivates the electrode. Over time, as the number of charging cycles increases, film thickness increases on the surface of the electrode which increases the resistance or impedance to the flow of electrons also increases. TABLE 2 tabulates physical properties of electrolyte solutions containing an exemplary TPFPB electrolyte additive compared with the baseline electrolyte containing no electrolyte additive:

TABLE 2 tabulates physical properties of electrolyte solutions.

| | Baseline | 0.1M TPFPB | 0.2M TPFPB |
|---|---|---|---|
| Physical Property | electrolyte | added | added |
| Conductivity (mS cm⁻¹) | 11.65 | 9.93 | 8.59 |
| Viscosity (cp) | 3.35 | 3.89 | 4.40 |

As shown in the TABLE, electrolyte conductivity decreases with increasing concentration of TPFPB in the electrolyte. Viscosity also increases with increasing concentration. The electrolyte containing 0.2 M TPFPB shows a slightly higher interfacial resistance (R_{ct}) due to the decreased conductivity and increased viscosity.

FIG. 5b plots impedance data measured in the electrolyte after 300 cycles in the baseline electrolyte with and without the electrolyte additive. The baseline electrolyte (i.e., absent the additive) shows an intermediate-frequency semicircle that appears in the spectrum at a Zᵣₑ value of about 150 ohms. The intermediate-frequency semicircle may be attributed to charge transfer resistance (R_{ct}) at the electrode/electrolyte interface. The intermediate-frequency semicircle shows that the impedance continues to increase over time and plateaus at a Zᵣₑ value of about 400. In contrast, in electrolytes containing either 0.1M TPFPB or 0.2M TPFPB, impedance curves are relatively straight compared with the baseline electrolyte and include low frequency tails. Low-frequency tails are associated with diffusion of Li⁺ ion in the solid electrode. Results show that diffusion of Li⁺ ion in electrolytes containing the electrolyte additive is easier than in the baseline electrolyte due to presence of passivation films in the baseline case. FIG. 5c expands the high-frequency semicircle observed at the low end of the spectrum of FIG. 5b. Data presented in the impedance spectra may be fitted using an equivalence circuit detailed, e.g., by Kang et al. [Electrochim. Acta, 50 (2005) 4784] and Zheng et al. [Electrochim. Acta, 105 (2013) 200]. Results are summarized in TABLE 3 below.

TABLE 3 lists fitted impedance spectra results for an exemplary Li[Li_{0.2}Ni_{0.2}Mn_{0.6]O}₂ composite cathode material before and after cycling.

| Cathode | | Baseline | 0.1M TPFPB | 0.2M TPFPB |
|---|---|---|---|---|
| Li[Li_{0.2}Ni_{0.2}Mn_{0.6}]O₂ | | electrolyte | added | added |
| Before cycling: | (R_{sf} + R_{ct}) | 63 | 57 | 74 |
| | (Ω) | | | |
| After 300 cycles: | R_{sf} (Ω) | 46 | 26 | 22 |
| | R_{ct} (Ω) | 654 | 375 | 350 |

Prior to cycling, the electrolyte containing 0.2 M TPFPB shows a higher interfacial resistance (R_{sf}+R_{ct}) compared to the 0.1M TPFPB case, which may be attributed to the increased viscosity and decreased conductivity observed in the 0.2M electrolyte additive (see TABLE 2). After 300 cycles, the electrode cycled in the electrolyte containing 0.2 M TPFPB additive exhibits a significantly lower surface film resistance (22Ω) compared to that prior to cycling. And, the surface film resistance is about half that of the battery (cell) cycled in electrolyte without additive (46Ω), indicating that the electrode surface has a much thinner passivation film. In addition, in 0.2 M TPFPB, the cell shows a charge-transfer resistance of 350Ω which again is about half that observed in the baseline electrolyte (654Ω). The stable interfacial resistances (i.e., R_{sf}+R_{ct}) in the presence of TPFPB additive reflect improved electron transfer at the electrode/electrolyte interface, which allows reversible and timely charge transfer.

### EXAMPLES

The following EXAMPLES provide a further understanding of various aspects of the present invention.

### Example 1

### Electrode Preparation

Li[Li_{0.2}Ni_{0.2}Mn_{0.6}]O₂ was prepared by a co-precipitation approach. Nickel sulfate hexahydrate (NiSO₄.6H₂O), manganese sulfate monohydrate (MnSO₄.H₂O), and sodium hydroxide (NaOH) were used as starting materials to prepare a Ni_{0.25}Mn_{0.75}(OH)₂ precursor. The precursor material was washed with deionized (DI) water to remove residual sodium and sulfate, then filtered and dried in a vacuum oven overnight at a temperature of 120° C. Ni_{0.25}Mn_{0.75}(OH)₂ was well mixed with Li₂CO₃ and then calcined at 900° C. for 24 hours to obtain the cathode materials.

### Example 2

### Preparation of Electrolytes

The baseline electrolyte was prepared by dissolving 1 M lithium hexafluorophosphate (LiPF₆) in ethyl carbonate (EC) and dimethyl carbonate (DMC) (1:2 in volume). Electrolytes containing TPFPB (Sigma-Aldrich, St. Louis, Mo., USA) additive were prepared by dissolving 1 M LiPF₆ and 0.1/0.2 mol TPFPB in EC/DMC solvents. Viscosity measurements were conducted on a Viscometer (e.g., a DV-II+ Pro Cone/Plate viscometer, Brookfield Engineering, Middleboro, Mass., USA). Conductivity measurements were made with a Multiparameter Meter (e.g., a 650 series multiparameter meter, Oakton Instruments, Pittsburgh, Pa., USA). Instruments were calibrated. Electrolytes were maintained at 25° C. in a constant temperature oil bath (Brookfield Circulating Bath Model TC-502).

### Example 3

### Electrochemical Performance Measurements

Cathode electrodes were prepared by coating a slurry containing 80% Li[Li_{0.2}Ni_{0.2}Mn_{0.6}]O₂, 10% super P (from Timcal), and 10% poly(vinylidene fluoride) (PVDF) (e.g., Kynar HSV900, Arkema Inc., King of Prussia, Pa., USA) binder onto an Al foil current collector. After drying, the electrodes were punched into disks with ø=1.27 cm. A typical loading of the cathode electrode was 3 mg cm⁻². Coin cells were assembled with as-prepared cathode electrodes, a lithium metallic foil as a counter electrode, a monolayer polyethylene (PE) membrane (e.g., K1640 PE membrane, Celgard LLC, Charlotte, N.C., USA) as a separator, and a carbonate-based electrolyte in an argon-filled glove box (e.g., MBraun Inc., Stratham, N.H., USA). Electrochemical performance tests were performed galvanostatically between 2.0 V and 4.7 V at C/3 (1 C=250 mA g⁻¹) after 3 formation cycles at C/10 on a battery tester (e.g., a model BT-2000 battery tester, Arbin Instruments, College Station, Tex., USA) at room temperature (˜25° C.). Oxidation potentials of the electrolytes without and with TPFPB additive were measured using a platinum (Pt) working electrode and Li metal as both counter and reference electrodes in a three-electrode cell. Electrochemical impedance spectra (EIS) measurements were made using an electrochemical station (e.g., a model 6005D electrochemical workstation, CH Instruments, Austin, Tex., USA) in a frequency range from 100 kHz to 10 mHz with a perturbation amplitude of ±10 mV.

While a number of embodiments of the present invention have been shown and described, it will be apparent to those skilled in the art that many changes and modifications may be made without departing from the invention in its broader aspects. The appended claims are therefore intended to cover all such changes and modifications as fall within the scope of the invention.

What is claimed is:

1. An electrolyte additive for a lithium ion battery, comprising:
an electron deficient boron-containing compound comprising one or more fluorinated aryl and/or fluorinated alkyl functional groups, the electrolyte additive when added to an electrolyte in contact with a lithium-containing cathode of the lithium ion battery decreases voltage fading of the battery to less than about 10% over a lifetime of at least about 300 charge-discharge cycles when compared to the lithium ion battery absent the electrolyte additive.

2. The electrolyte additive of claim 1, wherein the electrolyte additive when added to an electrolyte of the lithium ion battery reduces the capacity fading in the battery to less than about 20% on average over a lifetime of at least about 300 charge-discharge cycles compared with the lithium ion battery absent the electrolyte additive.

3. The electrolyte additive of claim 1, wherein the electrolyte additive includes tris(pentafluorophenyl)borane.

4. The electrolyte additive of claim 1, wherein the electrolyte additive includes a member selected from the group consisting of: 2-(pentafluorophenyl)-tetrafluoro-1,3,2-benzodioxaborole; 2-(pentafluorophenyl)-4,4,5,5-tetrakis(trifluoromethyl)-1,3,2-dioxaboralane; bis(1,1,1,3,3,3-hexafluoroisopropyl)pentafluorophenylboronate; 2,5-bis(trifluoromethyl phenyl)tetrafluoro-1,3,2-benzodioxaborole, and combinations thereof.

5. The electrolyte additive of claim 1, wherein the electron deficient boron-containing compound includes a concentration of between about 0.01 Mol/L and about 0.3 Mol/L.

6. The electrolyte additive of claim 1, wherein the electrolyte additive includes perfluorotributylamine (PFTBA) at a concentration of between about 0.1 wt % and about 3 wt %.

7. The electrolyte additive of claim 1, wherein the electrolyte additive decreases the breakdown of the electrolyte of the lithium ion battery at charging voltages or cut-off voltages less than about 5 V when compared to the electrolyte absent the electrolyte additive.

8. The electrolyte additive of claim 1, wherein the electrolyte additive is introduced as a component of a carbonate-based electrolyte.

9. The electrolyte additive of claim 1, wherein the electrolyte additive is introduced as a component of an electrolyte comprising lithium hexafluorophosphate (LIPF₆) in a solvent comprising ethylene carbonate (EC) and dimethyl carbonate (DMC).

10. The electrolyte additive of claim 1, wherein the electrolyte additive in the electrolyte is in contact with a composite cathode comprising xLi₂MnO₃.(1-x)LiMO₂, where (M) is a metal selected from the group consisting of: lithium (Li), nickel (Ni), cobalt (Co), manganese (Mn), and combinations thereof; and (x) is a number from 1 to 0.

11. A lithium ion battery, comprising:
a cathode comprising a lithium-containing composite; and
an electrolyte in contact with the composite cathode, the electrolyte includes an electrolyte additive comprising an electron deficient boron-containing compound comprising one or more fluorinated aryl and/or fluorinated alkyl functional groups, the electrolyte additive decreases voltage fading of the lithium ion battery to less than about 10% over a lifetime of at least about 300 charge-discharge cycles when compared to the lithium ion battery absent the electrolyte additive.

12. The lithium ion battery of claim 11, wherein the electrolyte additive reduces the capacity fading in the battery to less than about 20% on average over a lifetime of at least about 300 charge-discharge cycles compared with the lithium ion battery absent the electrolyte additive.

13. The lithium ion battery of claim 11, wherein the electrolyte additive decreases the breakdown of the electrolyte of the lithium ion battery at charging voltages or cut-off voltages less than about 5 V when compared to the electrolyte absent the electrolyte additive.

14. The lithium ion battery of claim 11, wherein the electrolyte additive includes tris(pentafluorophenyl)borane.

15. The lithium ion battery of claim 11, wherein the electrolyte additive includes: 2-(pentafluorophenyl)-tetrafluoro-1,3,2-benzodioxaborole; 2-(pentafluorophenyl)-4,4,5,5-tetrakis(trifluoromethyl)-1,3,2-dioxaboralane; bis(1,1,1,3,3,3-hexafluoroisopropyl)pentafluorophenylboronate; 2,5-bis(trifluoromethyl phenyl)-tetrafluoro-1,3,2-benzodioxaborole; and combinations thereof.

16. The lithium ion battery of claim 11, wherein the electrolyte additive includes perfluorotributylamine (PFTBA).

17. The lithium ion battery of claim 11, wherein the electrolyte additive includes a concentration between about 0.01 Mol/L and about 0.3 Mol/L.

18. The lithium ion battery of claim 11, wherein the electrolyte includes lithium hexafluorophosphate (LIPF₆) in a solvent comprising ethylene carbonate (EC) and dimethyl carbonate (DMC).

19. The lithium ion battery of claim 18, wherein the concentration of LiPF₆ in the electrolyte is between about 0.1 Mol/L and about 1 Mol/L and the ethylene carbonate (EC) to dimethyl carbonate (DMC) are in a ratio of [1:2] by volume.
